(19) United States
(12) Patent Application Publication
(10) Pub. No.: US 2025/0252456 A1
(43) Pub. Date: Aug. 7, 2025

(54) SYSTEMS AND METHODS FOR GENERATING CONTENT SHARING PLATFORM RECOMMENDATIONS USING MACHINE LEARNING

(71) Applicant: Google LLC, Mountain View, CA (US)

(72) Inventors: Jing Lu, Burlingame, CA (US); Fei Dong, Palo Alto, CA (US); Ravi Viswanathan, Sunnyvale, CA (US)

(21) Appl. No.: 18/432,534

(22) Filed: Feb. 5, 2024

(51) Int. Cl. G06Q 30/0242; H04N 21/81

(52) U.S. Cl. CPC G06Q 30/0242; H04N 21/812

(57) ABSTRACT

A method includes identifying a channel associated with a user of a content sharing platform and providing an indication of one or more features associated with the channel as input to an AI model. The AI model is trained to generate predictions reflecting expected earnings from enabling a particular type of advertisement in one or more media items associated with the channel. One or more outputs of the AI model are obtained. The one or more obtained outputs comprise a prediction reflecting expected earnings from enabling the particular type of advertisement in one or more media items associated with the channel. A recommendation based on the expected earnings is generated and an indicator referencing the recommendation is sent to the user.

### TECHNICAL FIELD

The disclosed implementations relate to methods and systems for generating content sharing platform recommendations using machine learning.

### BACKGROUND

Content sharing platforms allow users to connect to and share information with each other. Many content sharing platforms include a content sharing aspect that allows users to upload, view, and share content, such as video items, image items, audio items, and so on. Other users of the content sharing platform can comment on the shared content, discover new content, locate updates, share content, and otherwise interact with the provided content. The shared content can include content from professional channel owners, e.g., movie clips, TV clips, and music video items, as well as content from amateur channel owners, e.g., video blogging and short original video items.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

An aspect of the disclosure provides a computer-implemented method comprising identifying, by a processor, a channel associated with a user of a content sharing platform and providing an indication of one or more features associated with the channel as input to a machine learning model. The machine learning model is trained to generate predictions reflecting expected earnings from enabling a particular type of advertisement in one or more media items associated with the channel. One or more outputs of the machine learning model are obtained. The one or more obtained outputs comprise a prediction reflecting expected earnings from enabling the particular type of advertisement in one or more media items associated with the channel. A recommendation based on the expected earnings is generated and an indicator referencing the recommendation is sent to the user.

A further aspect of the disclosure provides a system comprising: a memory; and a processing device, coupled to the memory, the processing device to perform a method according to any aspect or implementation described herein.

A further aspect of the disclosure provides a non-transitory computer-readable medium comprising instructions that, responsive to execution by a processing device, cause the processing device to perform operations according to any aspect or implementation described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of system architecture, in accordance with implementations of the disclosure.

FIG. 2 depicts a flow diagram of an example method for training a earnings machine learning model to generate personalized data related to content access levels, in accordance with implementations of the present disclosure, in accordance with implementations of the disclosure.

FIG. 3 depicts a flow diagram of an example method for generating advertisement recommendations using the earnings machine learning model, in accordance with implementations of the disclosure.

FIGS. 4A-B are illustrations of example graphical user interfaces (GUIs) showing an advertisement recommendation on a channel owner's channel, in accordance with implementations of the disclosure.

FIG. 5 is a flow diagram of an example method for determining a channel level predicted additional earnings using AI model, in accordance with implementations of the disclosure.

FIG. 6 is a flow diagram of an example method for generating a channel level earnings AI model, in accordance with implementations of the present disclosure.

FIG. 7 is a block diagram illustrating an example training of an earning model, in accordance with implementation of the present disclosure.

FIG. 8 is a block diagram illustrating example architecture of a video item level AI model, in accordance with implementation of the present disclosure.

FIG. 9 is a block diagram illustrating example architecture of a channel level AI model, in accordance with implementation of the present disclosure.

FIG. 10 depicts a block diagram of an example computing device operating in accordance with one or more aspects of the present disclosure.

### DETAILED DESCRIPTION

The content served by content sharing platforms can include video content, image content, audio content, text content, and so on (which may be collectively referred to as “media items”). Such media items can include audio clips, movie clips, TV clips, and music videos, as well as amateur content such as video blogging, short original videos, pictures, photos, other multimedia content, etc. In some content sharing platforms, channel owners can provide their content to other users via one or more personal channels (“channel”). A channel can be data content available from a common source or data content having a common topic, theme, or substance. The channel can serve as a homepage for the channel owner's account and include media items having a common topic, theme, or substance. The media items can be chosen, made available, and/or uploaded by the channel owner to the channel. The channel owner can further customize their channel(s) by selecting a background and color scheme, controlling some of the information that appears on the channel, etc.

Channel owners can enable certain content-related features to monetize their channel(s). For example, channel owners can realize earnings from advertisements (“ads”) that would appear during certain segments of certain media items, receive earnings from viewers via a gratuity feature, sell merchandise, offer viewers (e.g., users of the content sharing platform) one or more particular levels of content access (a feature that allows “members” to join a channel through monthly fees and receive members-only benefits), etc. Advertisements are typically a primary source of earnings that can appear at different portions of a media item (e.g., a video item), such as prior to the start of the media item (referred to as a pre-roll ad), in between different segments of the media item (referred to as a mid-roll ad(s)), or after the completion of the media item (referred to as a post-roll ad).

A content sharing platform can generate recommendations to channel owners advising them to enable certain content-related features. For example, a content sharing platform can recommend channel owners to enable advertising against their content or to provide particular levels of content access. However, these recommendations are generally broadly targeted, fail to convey the beneficial impact of these features, and channel owners can receive multiple recommendations on a periodic basis. As such, many channel owners typically ignore these recommendations because they fail to see the value in them, while some channel owners that do adopt the recommendations fail to realize any significant benefit. As a result, computing resources consumed by content sharing platforms in generating the recommendations to a disinterested group of users are aimlessly expended. In addition, enabling advertisements in certain instances can marginally increase earning at the cost of irritating users, thus diminishing a subscriber base and causing the channel owner to lose potential future earnings.

Aspects and implementations of the present disclosure address the above and other deficiencies by providing a system for generating, for specific channel owners, personalized advertisement recommendations that can convey the potential impact of enabling specific types of advertisements in the media items on their channel. An advertisement recommendation can include personalized data related to enabling a specific type of advertisement (e.g., pre-roll ads, mid-roll ads, post-roll ads, etc.) in the media items on a particular channel. In an illustrative example, the advertisement recommendation can be in the form of a pop-up message on a channel's user interface or an email. In some instances, the advertisement recommendation can be indicative of the amount of additional earnings the channel owner can expect (e.g., over a certain time period) if the channel owner enables the advertisements in the media items on a channel. For example, an advertisement recommendation can indicate to the channel owner that, by enabling mid-roll ads, the channel owner can expect, in addition to current earnings, an additional percentage in earnings (e.g., up to an additional ten percent in earning). The current earnings can refer to the earnings that the channel owner is projected to receive during the current earnings period from other content-related features currently enabled on their channel.

An artificial intelligence (AI) model can be trained to generate advertisement recommendations. The AI model can be trained using certain channel features and/or media item features corresponding to media items on a channel. A channel feature can correspond to certain types of data related to the particular channel. More specifically, a channel feature can be data corresponding to characteristics data of the channel, viewer activity data related to the channel, engagement data related to the channel, earnings data related to the channel, monetization settings related to the channel, and so forth. A media item feature can correspond to certain types of data related to a particular media item on the channel (e.g., characteristics data related to the media item, viewer activity data related to the media item, engagement data related to the media item, etc.) In some implementations, the AI model can be trained to learn relationships between certain channel feature(s) of a channel with a particular enabled advertisement for its media items (e.g., mid-roll ads) and the ad earnings generated by the channel within a predetermined time frame. In some implementations, the AI model can be trained to learn relationships between certain media item feature(s) of a media item with a particular enabled advertisement and the ad earnings generated by the media item within a predetermined time frame. In other implementations, the AI model can be trained using any combination of the channel features and the media item features.

The trained AI model can then receive, as input, channel features (and/or media item features) of a particular channel and generate, as output, an ad earnings prediction for the channel (e.g., a prediction of how much earnings would be generated if a particular type of advertisements, such as mid-roll ads) were enabled in the video items on the channel). A recommendation engine can then determine the current earnings for the channel and, using the ad earnings prediction, determine the predicted additional earnings that can be generated for the channel by enabling the particular advertisements (e.g., mid-roll ads). The predicted additional earnings can be reflected as a percentage increase or decrease that is determined using the ad earnings prediction for the channel and the projected earnings for the channel. Alternatively, in some implementations, the predicted additional earnings can be reflected as monetary value increase determined based on the ad earnings prediction for the channel. The recommendation engine can then send an advertisement recommendation indicating the predicted additional earnings to the channel owner.

In an illustrative example, the trained AI model can be a media item level model and channel level model. Media item level models can use the media items features of media items to predict ad earnings. Media item level models can be more closely tied to individual media items (e.g., video items) and, thus, better capture trends and patterns of specific media items. Media item level models can be trained using media items that have recently (e.g., withing a predetermined time period, such as, the previous 30 days) enabled a particular advertisement (e.g., mid-roll ads). This training data can be historical data (e.g., previously recorded data). In some implementations, media items features generated prior to a specific point in time can be mapped to earnings generated after the point in time. During inference, the media level model can be used to generate predicted additional earnings on each media item of a channel with disabled mid-roll ads, then combine the predicted additional earnings to calculate the overall predicted additional earnings for the channel.

Channel level models can have a structure similar to that of the media item level model, but aggregate certain channel features of the channel rather than certain media item features. This can enable capturing the overall tread of the channel rather than the details of individual media items. Similar to the channel level model, the channel level model trained using media items features generated prior to a specific point in time mapped to earnings generated after the point in time. In addition, channel level models can be trained by using data reflecting estimated earnings for the media items (rather than historical data). In some implementations, the estimated earnings can be determined based on the predicted number of daily views for a media item multiplied by the revenue per impression (e.g., an ad view). The estimated earnings can be aggerated at a channel level and used to train the channel level model.

Aspects of the present disclosure result in improved performance of recommendation tools. In particular, the aspects of the present disclosure enable generating personalized and targeted advertisement recommendations for respective target channels. As a result, the recommendations specifically target particular channel owners, accurately convey the beneficial impact of enabling a type of advertisement (e.g., mid-roll ads) in the media items on their channels, and improve the conversion rate of dispatched recommendations. In addition, by generating personalized and targeted advertisement recommendations, considerable time and computing resources aimlessly expended by conventional content sharing platforms are saved.

Implementations of the present disclosure may be discussed with reference to mid-roll ads. However, it is noted that implementations of the present disclosure can be used with any type of advertisement, such as, for example, pre-roll ads, post-roll ads, pop-up ads, etc.

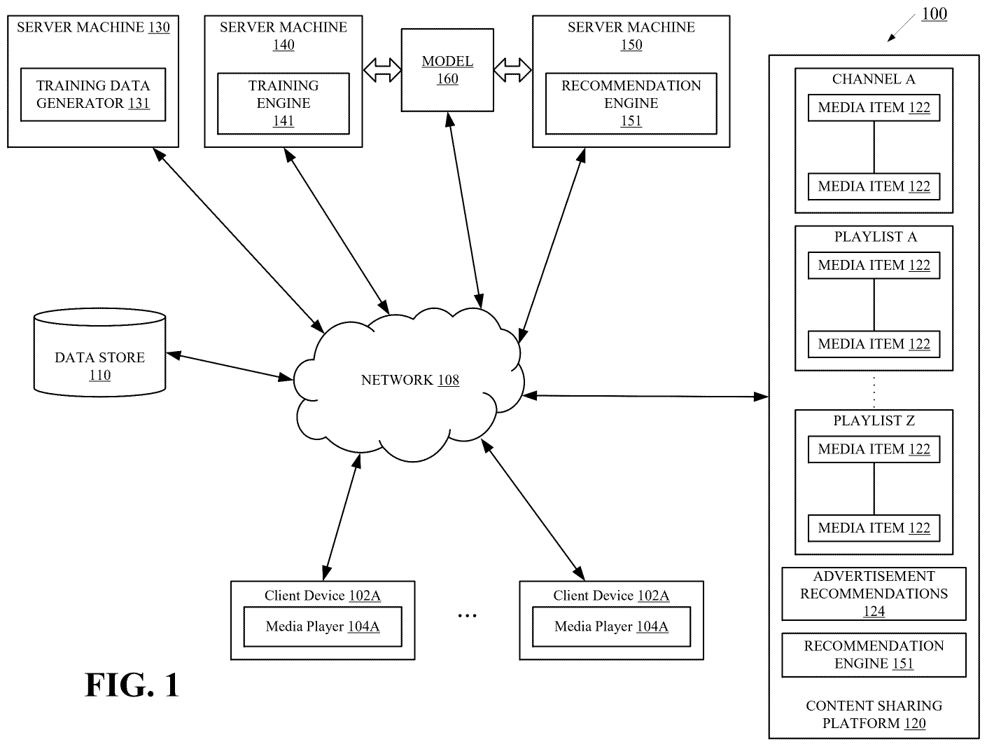

FIG. 1 illustrates an example system architecture 100, in accordance with implementations of the present disclosure. The system architecture 100 (also referred to as “system” herein) includes client devices 102A-102N, data store 110, content sharing platform 120, and/or server machines 130, 140, 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some implementations, data store 110 can be a network-attached file server, while in other implementations data store 110 can be some other type of persistent storage such as an object-oriented database, a relational database, and so forth, that may be hosted by application server 120 or one or more different machines (e.g., server machines 130, 140, 150, client device 102A-102N) coupled to the platform 120 via network 108.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices.” In some implementations, each client device 102A-102N can include a media player 104A-104N. In some implementations, media player 104A-104N can be applications that allow users, such as channel owners, viewers, etc. to play back, view, or upload content, such as images, video items, web pages, documents, audio items, etc. For example, media players 104A-104N can be a web browser that can access, retrieve, present, or navigate content (e.g., web pages such as Hyper Text Markup Language (HTML) pages, digital media items, etc.) served by a web server. Media player 104A-104N can render, display, or present the content (e.g., a web page, a media viewer) to a user. In some implementations, media player 104A-104N can provide a user interface for presenting the media items and/or enabling user interaction with the media player 104A-104N. Media player 104A-104N can also include an embedded media player (e.g., a Flash® player or an HTML5 player) that is embedded in a web page (e.g., a web page that can provide information about a product sold by an online merchant). In another example, media players 104A-104N can be a standalone application (e.g., a mobile application, or native application) that allows users to playback digital media items (e.g., digital video items, digital images, electronic books, etc.). According to aspects of the present disclosure, media players 104A-104N can be a content sharing platform application for users to record, edit, and/or upload content for sharing on the content sharing platform. As such, media players 104A-104N can be provided to client devices 102A-102N by content sharing platform 120. For example, media players 104A-104N can be embedded media players that are embedded in web pages provided by the content sharing platform 120. In another example, media players 104A-104N can be applications that are downloaded from content sharing platform 120.

In some implementations, content sharing platform 120 and server machines 130, 140, 150, can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that can be used to provide a user with access to media items or provide the media items to the user. Content sharing platform 120 can allow a user to consume, upload, search for, approve of (“like”), disapprove of (“dislike”), or comment on media items. Content sharing platform 120 can also include a website (e.g., a webpage) or application back-end software that can be used to provide a user with access to the media items.

In some implementations of the disclosure, a “user” can be represented as a single individual. However, other implementations of the disclosure encompass a “user” being an entity controlled by a set of users and/or an automated source. For example, a set of individual users federated as a community in a social network can be considered a “user”. In another example, an automated consumer can be an automated ingestion pipeline, such as a topic channel, of the content sharing platform 120. In some implementations, the user can access content on sharing platform 120 through a user account. The user can access (e.g., log in to) the user account by providing user account information (e.g., username and password) via an application on client device 110 (e.g., media player 104A-104N). In some implementations, the user account can be associated with a single user. In other implementations, the user account can be a shared account (e.g., family account shared by multiple users) (also referred to as “shared user account” herein). The shared account can have multiple user profiles, each associated with a different user. The multiple users can login to the shared account using the same account information or different account information. In some implementations, the multiple users of the shared account can be differentiated based on the different user profiles of the shared account.

In some implementations, an authorizing data service (also referred to as a “core data service” or “authorizing data source” herein) is a secure service that has access to data pertaining to user accounts on the content sharing platform 120 and that can use this data to decide whether to authorize a user account to obtain a requested content. In some implementations, the authorizing data service can authorize a user account (e.g., a client device associated with the user account) to access the requested content, authorize delivery of the requested content to the client device, or both. Authorization of the delivery of the content can involve authorizing how the content is delivered. In some implementations, the authorizing data service can use user account information to authorize the user account. In some implementations, an authentication token associated with client device 102A-102N or media player 104A-104N can be used to determine whether to authorize the user account and/or playback of requested content. In some implementations, the authorizing data service is part of content sharing platform 120. In other implementations, the authorizing data service can be an external service, such as a highly-secured authorizing service offered by a third-party.

In some implementations, content delivery platform 120 can use a content distribution network (CDN) (not shown) to stream the media items to one or more client devices 102A-102N for consumption by users. A CDN includes a geographically distributed network of servers that work together to provide fast delivery of content. The network of the servers can be geographically distributed to provide high availability and high performance by distributing content or services based, in some instances, on proximity to client devices 102A-102Z. The closer a CDN server is to a client device 102A-102N, the faster the content can be delivered to the client device 102A-102N.

A media item can include an electronic file that can be executed or loaded using software, firmware or hardware configured to present the media item to a user. A media item 122 can include, and is not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, etc. In some implementations, the media item 122 can be a live-stream media item. In some implementations, content sharing platform 120 can store the media items 122 using the data store 106, or can the media items (or and identifier of the media item) as electronic files in one or more formats using data store 106.

A video item is used as an example of a media item 122 throughout this disclosure. A video item is a set of sequential image frames representing a scene in motion. For example, a series of sequential image frames can be captured continuously or later reconstructed to produce animation. Video items can be presented in various formats including, but not limited to, analog, digital, two-dimensional and three-dimensional video. Further, video items can include movies, video clips or any set of animated images to be displayed in sequence. In addition, a video item (or media item) can be stored as a video file that includes a video component and an audio component. The video component can refer to video data in a video coding format or image coding format (e.g., H.264 (MPEG-4 AVC), H.264 MPEG-4 Part 2, Graphic Interchange Format (GIF), WebP, etc.). The audio component can refer to audio data in an audio coding format (e.g., advanced audio coding (AAC), MP3, etc.). It can be noted GIF can be saved as an image file (e.g., .gif file) or saved as a series of images into an animated GIF (e.g., GIF89a format). It can be noted that H.264 can be a video coding format that is a block-oriented motion-compensation-based video compression standard for recording, compression, or distribution of video content, for example.

In some implementations, the media item can be streamed, such as in a live-stream, to one or more of client devices 110A-110Z. It is be noted that “streamed” or “streaming” refers to a transmission or broadcast of content, such as a media item, where the received portions of the media item can be played back by a receiving device immediately upon receipt (within technological limitations) or while other portions of the media content are being delivered, and without the entire media item having been received by the receiving device. “Stream” can refer to content, such as a media item, that is streamed or streaming. A live-stream media item can refer to a live broadcast or transmission of a live event, where the media item is concurrently transmitted (e.g., from media capturing device 115A-115Z), at least in part, as the event occurs to a receiving device, and where the media item is not available in its entirety.

In some implementations, content sharing platform 120 can allow users to create, share, view or use playlists containing media items (e.g., playlist A-Z, containing media items 122). A playlist refers to a collection of media items that are configured to play one after another in a particular order without any user interaction. In some implementations, content sharing platform 120 can maintain the playlist on behalf of a user. In some implementations, the playlist feature of the content sharing platform 120 allows users to group their favorite media items together in a single location for playback. In some implementations, content sharing platform 120 can send a media item on a playlist to client device 110 for playback or display. For example, media player 104A-104N can be used to play the media items on a playlist in the order in which the media items are listed on the playlist. In another example, a user can transition between media items on a playlist. In yet another example, a user can wait for the next media item on the playlist to play or can select a particular media item in the playlist for playback.

The content sharing platform 120 can include multiple channels (e.g., channels A through Z, of which only channel A is shown in FIG. 1) for providing media items from a common source or having a common topic, theme, or substance. Each channel can include one or more media items and can be managed by an owner (referred to as a “channel owner”), who is a user that can perform administrative actions on the channel. The administrative actions can include making media items available on the channel (e.g., choosing, uploading, and/or allowing presentation of the media items), enabling advertisements for the media items, etc. For example, a channel X (not shown) can include video media items Y and Z that were uploaded by the channel owner.

In some implementations, the owner of a channel (e.g., a channel owner) can enable advertisements in one or more media items on one or more channels. Advertisements can be enabled at different portions of a media item (e.g., a video item), such as prior to the start of the media item (referred to as a pre-roll ad), in between different segments of the media item (referred to as a mid-roll ad(s)), after the completion of the media item (referred to as a post-roll ad), as a pop-up banner or button, etc. The owner can enable one or more types of advertisements for a particular video, for a set of videos on a particular channel, or for each video on the channel.

In some implementations, content sharing platform 120 (and/or server machine 150) can include recommendation engine 151 that can generate advertisement recommendations 124 to one or more users (e.g., channel owners) of content sharing platform 120. An advertisement recommendation 124 can be an indicator (e.g., interface component such as, for example, a popup message, electronic message, recommendation feed, etc.) that provides a channel owner with personalized data related to enabling (e.g., activating) advertisements (e.g., pre-roll ads, mid-roll ads, post-roll ads, pop-up ads, etc.) on a particular channel. In some implementations, an advertisement recommendation 124 can be indicative of how much additional ad earnings the channel is likely to generate within a certain number of days (e.g., from an effective date) from the channel owner enabling advertisements in the media items on the channel. For example, an advertisement recommendation 124 can indicate to the channel owner that, by enabling mid-roll ads in all of the video items on their channel, the channel owner can expect an extra ten percent in ad earnings on their next earnings distribution.

In some implementations, an advertisement recommendation 124 can be made using data from a variety of sources including historical and/or current data related to other users, channels, media items, ad earnings received and/or projected ad earnings, membership plans, playlist media items, recently watched media items, media item ratings, information from a cookie(s), user history, regional data, viewer activity, fanship data (e.g., number of likes, number of subscribers, number of shares, etc.) and other sources. In some implementations, a recommendation can be based on an output of trained AI model 160. In some implementations, the advertisement recommendation 124 can be presented on media player 104A-104N (e.g., on the user interface associated with a channel of a channel owner), sent to a different application associated with the channel owner (e.g., sent as an email to an email address related to the channel creator, sent as a text to a phone number related to the channel creator, etc.) and/or provided to the channel owner using other means.

AI model 160 can be a machine learning model trained to generate the advertisement recommendations. In particular, the AI model 160 can be trained to learn relationships 1) between certain channel feature(s) of a channel with a particular enabled advertisement for its media items (e.g., mid-roll ads) and the ad earnings generated by the channel within a predetermined time frame, 2) between certain media item feature(s) of a media item with a particular enabled advertisement and the ad earnings generated by the media item within a predetermined time frame, 3) or any combination thereof. In some implementations, to generate advertisement recommendation 124, recommendation engine 151 can receive, as input for a trained AI model 160, data reflecting channel features and/or media item features of a channel and obtain, as output from the trained AI model, data reflecting the ad earnings prediction for the channel. In some implementations, recommendation engine 151 can then determine the projected current earnings for the channel. In some implementations, recommendation engine 151 can determine, using the ad earnings prediction and the current earnings (earnings that the channel owner is projected to receive during the current earnings period from other content-related features currently enabled on their channel), the predicted additional earnings that can be generated for the channel by enabling the particular advertisements (e.g., mid-roll ads). The predicted additional earnings can be reflected as a percentage increase determined based on the ad earnings prediction for the channel and the projected current earnings for the channel (e.g., % increase=(100/projected current earnings*(projected current earnings+ad earnings prediction)−100). Alternatively, in some implementations, the predicted additional earnings can be reflected as monetary value increase determined based on the ad earnings prediction for the channel.

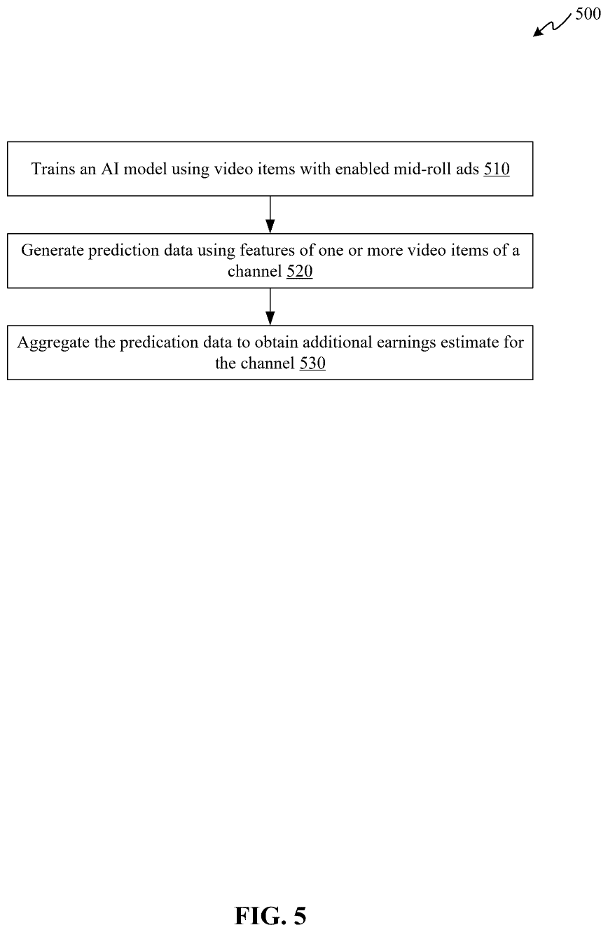

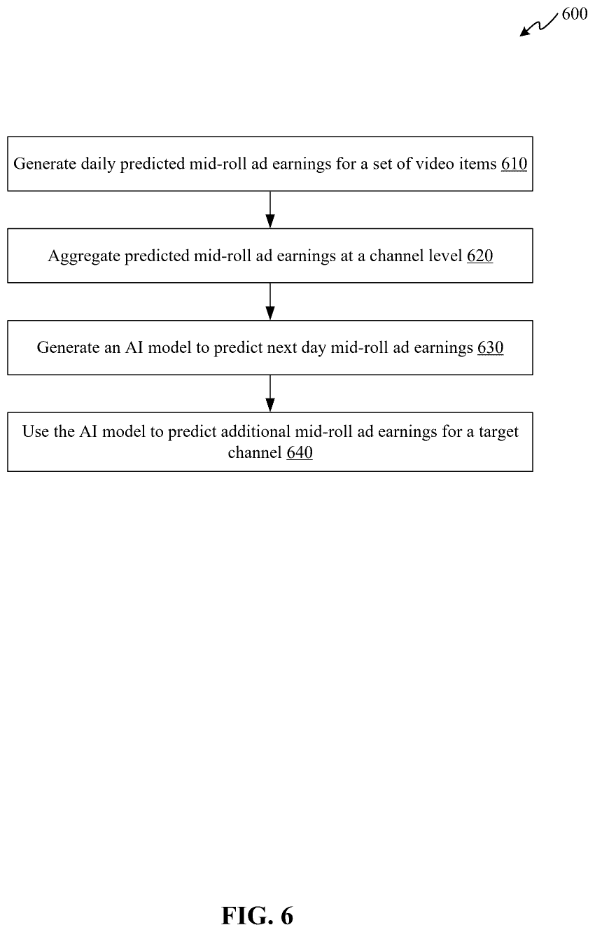

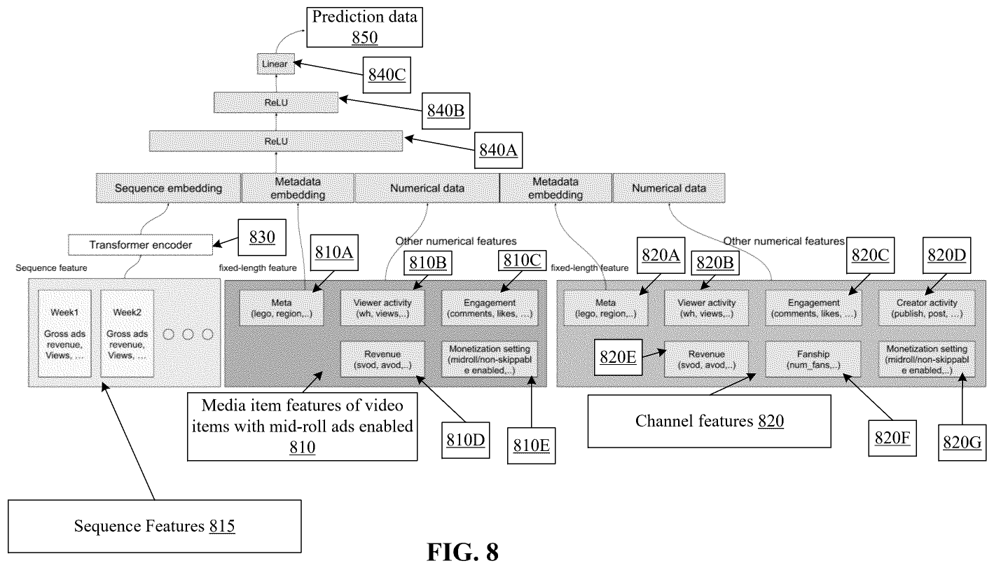

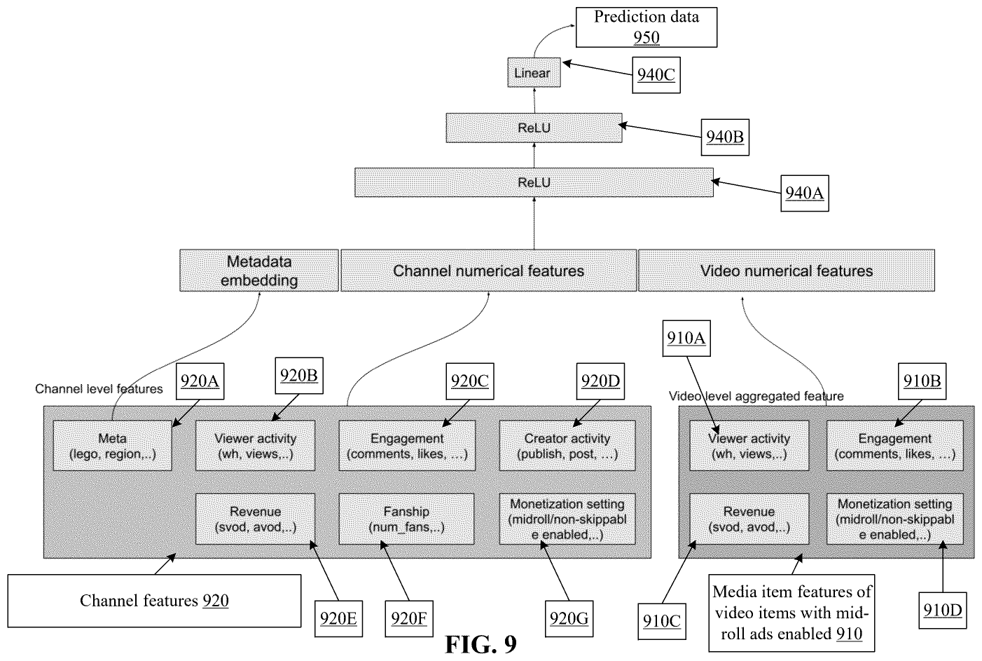

Various types of AL models 160 can be used to generate advertisement recommendations, such as, for example, media item level models and channel level models. Media item level models can use the media items features of media items to predict ad earnings and can be more closely tied to individual media items (e.g., video items), allowing them to better capture trends and patterns of specific media items. The media item level models are discussed in further detail in FIGS. 5 and 8. Channel level models can aggregate certain channel features of the channel rather than certain media item features, allowing them to capture the overall tread of the channel rather than the details of individual media items. The channel item level models are discussed in further detail in FIGS. 6 and 9.

Training data generator 131 (residing at server machine 130) can generate training data to be used to train earnings AI model 160. In some implementations, training data generator 131 can generate the training data using one or more channel features and/or media item features. A channel feature can correspond to certain types of data related to a particular channel. In particular, a channel feature can include characteristics data related to the channel, viewer activity data related to the channel, engagement data, earnings data, monetization settings, activities data, etc. The characteristics data can include descriptive or specific data related to the channel, such as the channel title, the geographic region associated with the channel, viewer demographics (e.g., viewer age, sex, location, etc.), etc. The viewer activity data can relate to metrics data associated with the viewers of the channel, such as, for example, the number of views recorded for the channel, the number of subscribers recorded for the channel, the number of times the channel was shared, watch hours, etc. The engagement data can relate to data pertaining to certain interactions between the viewers and the channel, such as, for example, the number of comments made on the channel's comments section, the number of likes recorded for the channel, etc. Earnings data can include data related to the earnings generated by the channel over a specific time period (e.g., over 7 days, 30 days, 60 days, etc.) by a particular earnings generating feature (e.g., ad earnings). In some implementations, the ad earnings data can relate to the ad earnings generated, by a particular type of advertisement, for one or more media items on a channel (or for the channel itself). In some implementations, the ad earnings can relate to a particular billing model implemented by the channel. For example, the channel can implement a SVOD (Subscription Video on Demand) model, a TVOD (Transactional Video on Demand) model, an AVOD (Advertising-Based Video on Demand and Free Ad-Supported) model, a hybrid earnings model, etc. Monetization settings can include data related to whether particular advertisements are enabled. For example, the monetization settings can relate to whether mid-roll ads are enabled for the entire channel, for a portion of the channel (e.g., for a certain number of media items on the channel), whether pre-roll ads are enabled, whether post-roll ads are enabled, the category of advertisements enabled (e.g., unskippable ads, skippable ads, 5 second ads, 30 second ads, and so forth), etc. The activities data can relate to channel owner activities on the channel, such as, for example, the number of media items added, number of playlists generated, type of content provided (e.g., livestreams, shorts, videos, etc.) etc. In some implementations, the training data can be historical training data (e.g., channel features or media item features that were previously recorded), predicated data, or any combination thereof. Predicated data can be generated using one or more of an AI or neural network model, heuristics, rule-based methods, extrapolation, etc. For example, the training data can include estimated ad revenue per media item which can be determined by obtaining a predicted number of views (per day, per week, etc.) for a media item and multiplying the predicated data by the expected revenue per ad view.

A media item feature can correspond to certain types of data related to a particular media item. In particular, a media item feature can be related to characteristics data related to the media item, viewer activity data related to the media item, engagement data related to the media item, earnings data related to the media item, monetization settings related to the media item, activities data related to the media item, etc. These features can be similar to those described in reference to channel features but related to a particular media item instead.

In some implementations, the channel features and/or media item features used by training data generator 131 can be from a particular time period (e.g., within the previous 30 days, 6 months, etc.). For example, the channel features and/or media item features used can include view activity data related to a media item from the previous 6 months, earnings data for the channel from the previous 30 days, particular engagement data from the previous 3 months and other engagement data from the previous 2 months, etc.

Server machine 140 may include a training engine 141. Training engine 141 can train the earnings AI model 160 using the training data from training data generator 131. In some implementations, the earnings AI model 160 can be created by the training engine 141 using the training data that includes training inputs (e.g., certain channel feature(s) and/or certain media item features) and corresponding target outputs (correct answers for respective training inputs, such as ad earnings generated by the channel within a predetermined time frame). The training engine 141 can find patterns in the training data that map the training input to the target output (the answer to be predicted) and provide the earnings AI model 160 that captures these patterns. The earnings AI model 160 can perform, e.g., a single level of linear or non-linear operations. An example of a deep network is a neural network with one or more hidden layers, and such a AI model can be trained by, for example, adjusting weights of a neural network in accordance with a backpropagation learning algorithm or the like. In other or similar implementations, the earnings AI model 160 can refer to the model artifact that is created by training engine 141 using training data that includes training inputs. Training engine 141 can find patterns in the training data, identify clusters of data that correspond to the identified patterns, and provide the earnings AI model 160 that captures these patterns. Earnings AI model 160 can use one or more of support vector machine (SVM), Radial Basis Function (RBF), clustering, supervised machine learning, semi-supervised machine learning, unsupervised machine learning, k-nearest neighbor algorithm (k-NN), linear regression, multi-linear regression, non-linear regression, random forest, gradient-boosted trees, neural network (e.g., artificial neural network), etc.

Server machine 150 can include recommendation engine 151, which can be configured to utilize earnings AI model 160 to generate prediction data for a particular channel. In particular, recommendation engine 151 can provide an identifier of the channel, as input, to the earnings AI model 160. In some implementations, the recommendation engine 151 can obtain, as input to the AI model, certain channel features associated with the channel and/or certain media item features from one or more media items on the channel. Recommendation engine 151 can then obtain one or more outputs from earnings AI model 160, the one or more outputs reflecting one or more advertisement recommendations 124. In particular, the earnings AI model 160 can provide one or more outputs that include data indicative of how much additional earnings (or how much total earnings) can be generated by the channel within a certain amount of time (e.g., within 30 days) from the owner of the channel enabling a particular type of advertisement (e.g., mid-roll ads). In some implementations, recommendation engine 151 can store the predicted output data (e.g., advertisement recommendations 124) on data store 110.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

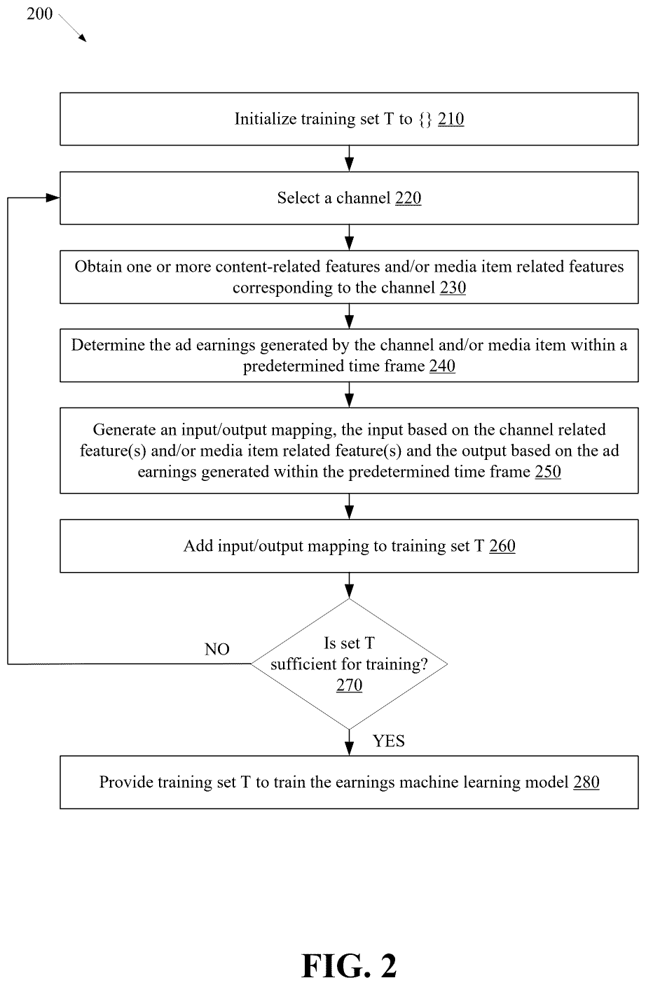

FIG. 2 depicts a flow diagram of an example method 200 for training an earnings AI model to generate personalized data related to expected channel earnings, in accordance with implementations of the present disclosure. Method 200 can be performed by processing logic that can include hardware (circuitry, dedicated logic, etc.), software (e.g., instructions run on a processing device), or a combination thereof. In one implementation, some or all of the operations of method 200 can be performed by one or more components of system 100 of FIG. 1. In some implementations, some or all of the operations of method 200 can be performed by training data generator 131 and/or training engine 141, as described above.

For simplicity of explanation, method 200, as well as any other method of this disclosure, is depicted and described as a series of acts. However, acts in accordance with this disclosure can occur in various orders and/or concurrently, and with other acts not presented and described herein. Furthermore, not all illustrated acts may be required to implement method 200 in accordance with the disclosed subject matter. In addition, those skilled in the art will understand and appreciate that method 200 could alternatively be represented as a series of interrelated states via a state diagram or events. Additionally, it should be appreciated that method 200 disclosed in this specification are capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At operation 210, processing logic initiates training set T to { } (e.g., to empty).

At operation 220, processing logic selects a channel. The channel can be a channel that has enabled a particular content-related feature, such as, for example, advertisement (e.g., mid-roll ads) for one or more media items on the channel. In some implementations, the channel selected can be a channel that had mid-roll ads enabled for a predetermined amount of time (e.g., enabled for 30 days, 60 days, etc.). In some implementations, the channel can be a channel that enabled mid-roll ads within a predetermined amount of time (e.g., enabled mid-roll ads less than a year prior, less than two years prior, etc.). In some implementations, the channel can be a currently active channel (e.g., a channel currently available on content sharing platform 120), an unavailable channel (e.g., a channel currently unavailable on content sharing platform 120, but data related to the channel, such as, channel features and/or media item features, is accessible from content sharing platform 120, from data store 110, etc.), etc.

At operation 230, processing logic obtains one or more channel features and/or one or more media item features corresponding to the channel. In some implementations, the channel feature(s) can be certain types of data (e.g., characteristics data, viewer activity data, engagement data, earnings data, monetization settings, activities data, etc.) related to the particular channel. The media item feature(s) can be certain types of data (e.g., characteristics data, viewer activity data, engagement data, earnings data, monetization settings, activities data, etc.) related to a media item on the particular channel. In some implementations, the channel features and/or media item features can be historical data (e.g., data previously obtained from content sharing platform 120 and stored on, for example, data store 110), can be current data, such as data obtained from a current channel, etc.

At operation 240, processing logic determines the ad earnings generated by the channel and/or the media item within a predetermined time frame. For example, processing logic can determine how much ad-earnings was generated by the channel during a particular 14-day time frame.

At operation 250, processing logic generates an input/output mapping, the input based on the channel feature(s) and/or media item feature(s) and the output based on the ad earnings generated within the predetermined time frame.

At operation 260, processing logic adds the input/output mapping to training set T.

At operation 270, processing logic determines whether set T is sufficient for training. In response to processing logic determining that set T is not sufficient for training, method 200 can return to operation 220. The processing logic can then select another channel, select different or additional channel features and/or media item features for a previously selected channel, etc. In response to processing logic determining that set T is sufficient for training, method 200 can proceed to operation 280.

At operation 280, processing logic provides training set T to train a AI model, such as earnings AI model 160, as described above.

Once processing logic provides the training set T to train the AI model, the AI model can be trained to generate, for a given channel, personalized data related to enabling (e.g., activating) a particular advertisement (e.g., mid-roll ads) on a particular channel, such as, an advertisement recommendation 124.

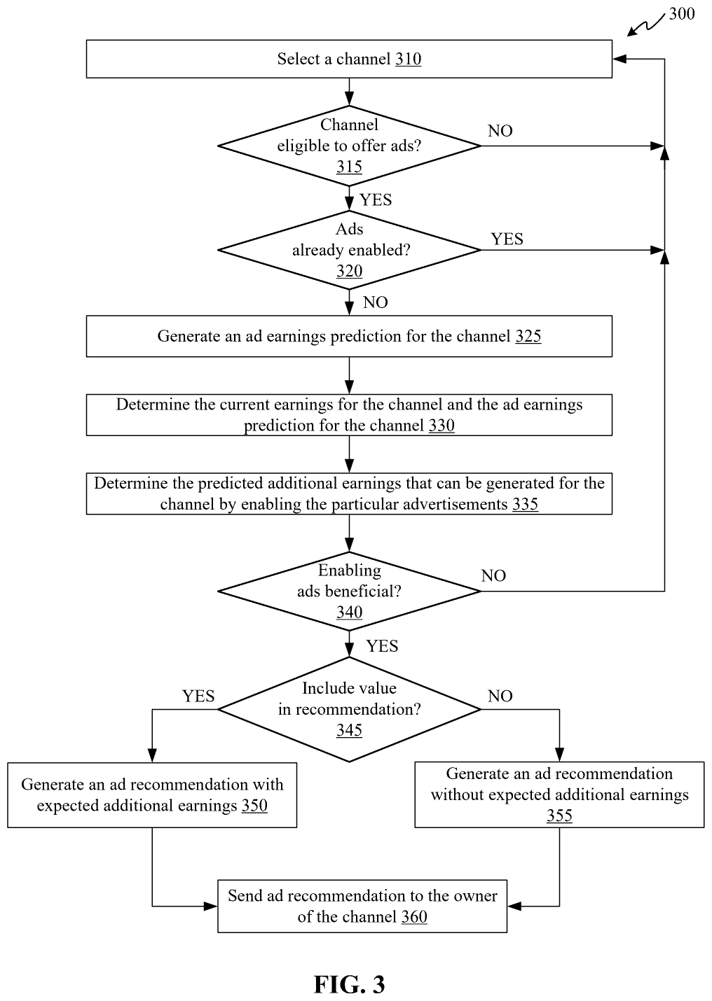

FIG. 3 depicts a flow diagram of an example method 300 for generating advertisement recommendations using the earnings AI model 160, in accordance with implementations of the present disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some embodiments, some or all of the operations of method 300 can be performed by recommendation engine 151, as described above.

At operation 310, processing logic selects a channel. The channel can be selected at random, based on a predetermined criterion (e.g., age of the channel, geographic region of the channel, type of channel, etc.).

At operation 315, processing logic determines whether the channel is eligible to offer particular advertisements (e.g., mid-roll ads) to viewers. In some implementations, the processing logic can determine whether the channel and/or channel owner (e.g., the channel owner of the channel) can provide access to certain content-related features (e.g., to monetization features) and/or whether the channel and/or the channel owner satisfies eligibility criteria. The eligibility criteria can relate to the number of subscribers to the channel, the number of public watch hours over a particular time period (e.g., 100 public watch hours over the previous month), the type of content offered, etc. Responsive to the processing logic determining that the channel is not eligible to offer advertisements to viewers, the processing logic proceeds to operation 310 and selects another channel. Responsive to the processing logic determining that the channel is eligible to offer advertisements to viewers, the processing logic proceeds to operation 330.

At operation 320, processing logic determines whether the channel has already enabled a particular type of advertisements, such as, for example, mid-roll ads. For example, the processing logic can determine whether the channel currently enabled mid-roll ads for all of the media items on the channel (as opposed to only certain media items or for no media items). Responsive to the processing logic determining that the channel already offers mid-roll ads for all of the media items on the channel, the processing logic proceeds to operation 310 and selects another channel. Responsive to the processing logic determining that the channel does not offer mid-roll ads, or only offers mid-roll ads for certain media items, the processing logic proceeds to operation 325.

At operation 325, processing logic generates an ad earnings prediction for the channel (during a predetermined time period). In particular, the processing logic obtains one or more channel features corresponding to the channel and/or one or more media item features corresponding to a media item(s) on the channel. Next, the processing logic provides an indication of the one or more channel features and/or media item features as input to earnings AI model 160. The earnings AI model 160 can be trained via, for example, method 200 of FIG. 2. Next, the processing logic, via the trained AI model, generates an ad earnings prediction for the channel. The ad earnings prediction can indicate how much ad earnings the channel owner can expect to receive, over a predetermined time period (e.g., daily, weekly, monthly, etc.), by enabling mid-roll ad for all of the media items on the channel (or for a particular number of media items on the channel).

At operation 330, processing logic determines the current earnings for the channel (during a predetermined time period). The current earnings can refer to the earnings that the channel owner is projected to receive during the current earnings period from other content-related features currently enabled on their channel. The current earnings can be determined using current content-related features enabled by the channel (e.g., gratuity features, merchandise for sale, particular levels of content access, particular advertisements enabled, etc.). In some implementations, the processing logic can determine the earnings already earned by the channel during a time frame (e.g., during the first ten days of a 30-day window) and extrapolate the earned earnings over the 30-day window to determine the projected current earnings. In some implementations, the processing logic can use statistical techniques, predictive techniques, and/or any other type of mathematical techniques to generate the current earnings.

At operation 335, processing logic determines the predicted additional earnings that can be generated for the channel by enabling the particular advertisements (e.g., mid-roll ads). In some implementations, the predicted additional earnings can be reflected as a percentage increase determined based on the ad earnings prediction for the channel and the current earnings for the channel (e.g., % increase=(100/current earnings*(current earnings+ad earnings prediction)−100). In some implementations, the predicted additional earnings can be reflected as monetary value increase determined based on the ad earnings prediction for the channel (thus, method 300 can skip operation 330). It is noted that the predicted additional earnings can indicate an expected decrease in earnings (referred to as negative additional earnings). This can result from, for example, a prediction that the additional revenue expected from enabling the advertisements will not compensate for the lost earnings from the newly added advertisements diminishing the channel's subscriber base.

At operation 340, processing logic determines whether enabling advertisements (e.g., mid-roll ads) for the channel is beneficial. In some implementations, the processing logic can determine whether the predicted additional earnings satisfy a benefit threshold criterion. The benefit threshold criterion can be used to filter trivial additional earning and/or negative additional earnings. Trivial additional earnings can be earnings that are deemed to be insignificant enough that sending an ad recommendation will likely cause an adverse reaction from the channel owner. The benefit threshold criterion can be set, for example, using user unput. In an example, responsive to the benefit threshold criterion being ten dollars, and the predicted additional earnings satisfying the benefit threshold criterion (e.g., the predicted additional earnings are equal to or greater than ten dollars), the processing logic can determine that enabling a particular type of advertisement (e.g., mid-roll ads) is beneficial for the channel. The benefit threshold criterion can be a predetermined value, a dynamic value, etc. used to determine whether to send the recommendation to the channel owner. The benefit threshold criterion can be based on monetary metrics, analytic data, operator (e.g., user) input, etc. Responsive to the processing logic determining that enabling advertisements is not beneficial to the channel owner (e.g., the predicted additional earnings fail to satisfy the benefit threshold criterion), the processing logic can reject generating an advertisement recommendation and proceed to operation 310 to select another channel. Responsive to the processing logic determining that enabling mid-roll ads is beneficial to the channel owner (e.g., the predicted additional earnings satisfy the benefit threshold criterion), the processing logic proceeds to operation 345.

At operation 345, processing logic determines whether to include the value of the predicted additional earnings in the advertisement recommendation. In some implementations, the processing logic can determine whether the predicted additional earnings satisfy a display threshold criterion. For example, responsive to the display threshold criterion being 3% additional earnings, and the predicted additional earnings satisfying the display threshold criterion (e.g., the predicted additional earnings is equal to or greater than 3% additional earnings), the processing logic can determine to include the value of the predicted additional earnings in the advertisement recommendation. The display threshold criterion can be a predetermined value, a dynamic value, etc. used to determine whether to include the value of the predicted additional earnings in the advertisement recommendation. The display threshold criterion can be based on monetary metrics, analytic data, operator (e.g., user) input, etc. Responsive to the processing logic determining to include the value of the predicted additional earnings in the advertisement recommendation (e.g., the predicted additional earnings satisfy the display threshold criterion), the processing logic proceeds to operation 350 and generates an ad recommendation with the predicted additional earnings. The advertisement recommendation can indicate how much additional earnings the channel owner can expect to receive by enabling mid-roll ads for all (or some) of the media items on the channel. For example, the advertisement recommendation can indicate that the channel can be expected to earn up to an additional 5 percent in earnings in response to enabling mid-roll ads. In some implementations, the message displayed can be based on the range that the additional earnings fall between. For example, if the additional earnings is between 5% and 10%, the message can indicate that that the channel can be expected to earn up to an additional 10% in earnings in response to enabling mid-roll ads, if the additional earnings is between 10.1% and 15%, the message can indicate that that the channel can be expected to earn up to an additional 15% in earnings in response to enabling mid-roll ads, and so forth.

Responsive to the processing logic determining not to include the value of the predicted additional earnings in the advertisement recommendation (e.g., the predicted additional earnings fail to satisfy the display threshold criterion), the processing logic proceeds to operation 355 and generates an ad recommendation without the predicted additional earnings. The advertisement recommendation can indicate that the channel can be expected to earn additional earnings in response to enabling mid-roll ads.

At operation 360, the processing logic sends the advertisement recommendation to the channel owner. In some implementations, the advertisement recommendation can be presented on the user interface associated with the channel, sent to an email address related to the channel owner, sent as a text to a phone number related to the channel owner, etc.

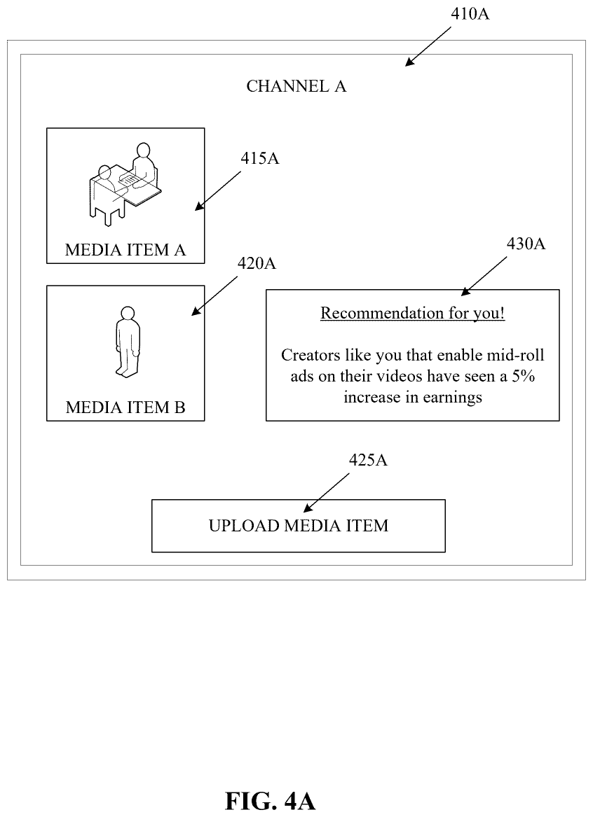

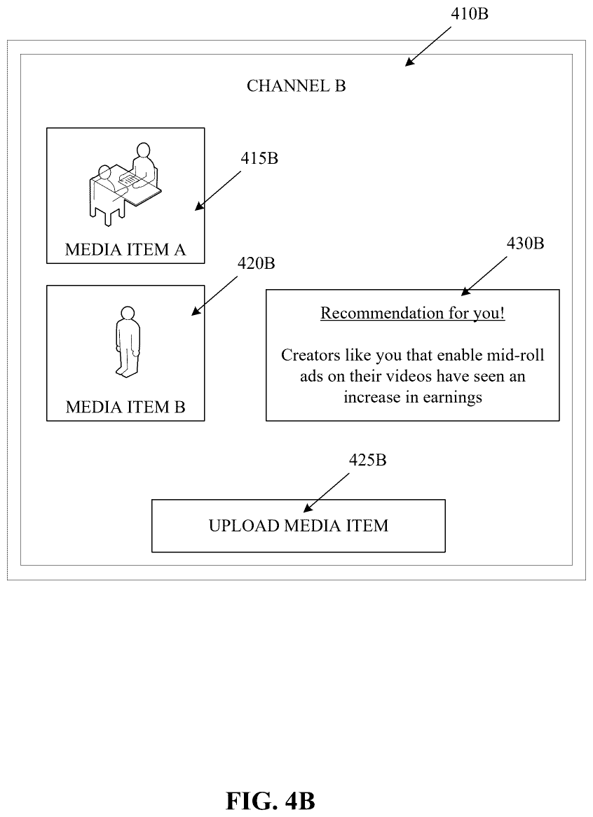

FIGS. 4A-4B are example graphical user interfaces (GUIs) showing advertisement recommendations on a channel owner's channels. In particular, FIG. 4A shows GUI 410A which allows a channel owner to edit channel A. Channel A includes two media items (media item A 415A and media item B 420A) uploaded to channel A by the channel owner. Button 425A allows the channel owner to upload additional media items. Advertisement recommendation 430A is a pop-up window displayed on GUI 410A. Advertisement recommendation 430A includes a message to the channel owner that was generated via operation 350 of method 300 (e.g., an ad recommendation with expected additional earnings) and reads “Creators like you that enable mid-roll ads on their videos have seen a 5% increase in earnings.”

FIG. 4B shows GUI 410B which allows the channel owner to edit channel B. Channel B includes two media items (media item A 415B and media item B 420B) uploaded to channel B by the channel owner. Button 425B allows the channel owner to upload additional media items. Advertisement recommendation 430B is a pop-up window displayed on GUI 410B. Advertisement recommendation 430B includes a message to the channel owner that was generated via operation 350 of method 300 (e.g., an ad recommendation without expected additional earnings) and reads “Creators like you that enable mid-roll ads on their videos have seen an increase in earnings.”

FIG. 5 is a flow diagram of an example method 500 for determining a channel level predicted additional earnings using AI model, in accordance with implementations of the present disclosure. Method 500 can be performed by processing logic that can include hardware (circuitry, dedicated logic, etc.), software (e.g., instructions run on a processing device), or a combination thereof. In one implementation, some or all of the operations of method 500 can be performed by one or more components of system 100 of FIG. 1. In some embodiments, some or all of the operations of method 500 can be performed by recommendation engine 151, as described above.

At operation 510, processing logic trains an AI model (e.g., AI model 160) using video items with enabled mid-roll ads. For example, processing logic can train AI model using method 200. In some implementations, the video items used for training can be video items that recently enabled mid-roll ads (e.g., within the last 30 days).

At operation 520, processing logic generates prediction data (e.g., predicted additional earnings) using features (e.g., video item features) of one or more video items of a channel. The one or more video items can video items where mid-roll ads are disabled.

At operation 530, processing logic aggregates the predication data to obtain additional earnings estimate for the channel. For example, if prediction data is generated for two video items out of eight video items on the channel, the processing logic can multiply the estimated additional earning by a factor of 4 (e.g., 8/2). To calculate a percentage value reflecting the additional earnings, the processing logic can divide the estimated additional earning for the channel by the last day's mid-roll ad earnings for that particular channel.

FIG. 6 is a flow diagram of an example method 600 for generating a channel level earnings AI model, in accordance with implementations of the present disclosure. Method 600 can be performed by processing logic that can include hardware (circuitry, dedicated logic, etc.), software (e.g., instructions run on a processing device), or a combination thereof. In one implementation, some or all of the operations of method 600 can be performed by one or more components of system 100 of FIG. 1. In some embodiments, some or all of the operations of method 600 can be performed by recommendation engine 151, as described above.

At operation 610, processing logic generates daily predicted mid-roll ad earnings for a set of video items. In some implementations, the processing logic can use a machine learning model or an AI model, such as, for example, a CPI (consumer price index) forecast model, model 160, etc.

At operation 620, processing logic aggregates predicted mid-roll ad earnings at a channel level. For example, if prediction data is generated for a video item and the channel include 5 video items on the channel, the processing logic can multiply the estimated additional earning by a factor of 5.

At operation 630, processing logic generates an AI model to predict next day mid-roll ad earnings. The AI model can be generated using method 200.

At operation 640, processing logic can use the AI model to predict additional mid-roll ad earnings for a target channel.

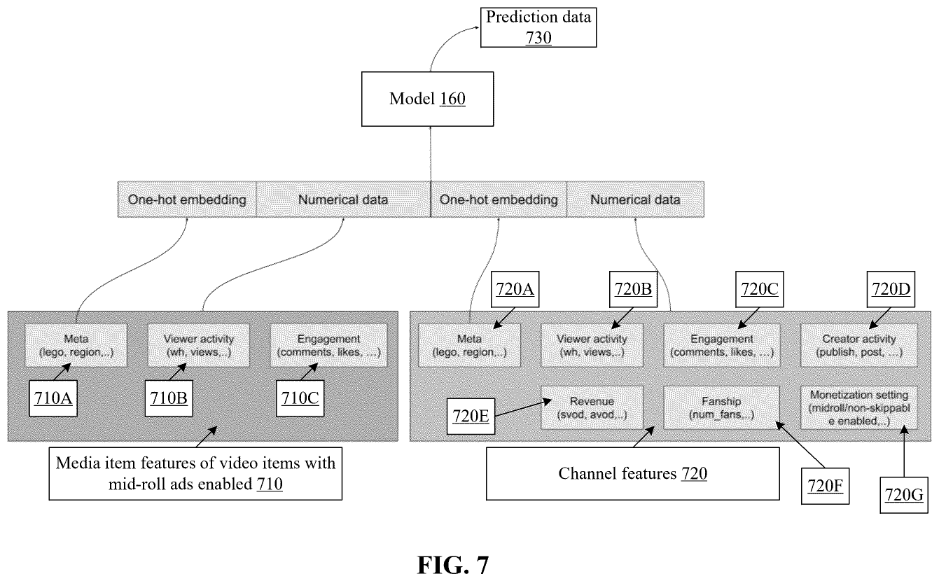

FIG. 7 is a block diagram illustrating example training of an earning model 160, in accordance with implementation of the present disclosure. As shown, channel level features 720 of a channel and media item features of video items with mid-roll ads enabled 710 can be used to train model 160. Media item features 710 can include metadata 710A, viewer activity data 710B, and engagement data 710C. Metadata 710A can reflect logged data of each media item, regional data of each media item, timestamp data of each media item (e.g., date and time of upload, when the media items was made available for viewing, when mid-roll ads were enabled, etc). Viewer activity data 710B can reflect the watch hours of each media item, the number of views each media item received, etc. Engagement data 710C can reflect the number of comments posted for each media item, the number of likes recorded for each media item, etc.

Channel features 720 can include metadata 720A, viewer activity data 720B, engagement data 720C, creator activity data 720D, revenue data 720E, fanship data 720F, and monetization settings 720G. Metadata 710A can reflect logged data of each channel, regional data of each channel, timestamp data of each channel (e.g., date and time of channel creation, when the channel was made available for viewing, when channel level mid-roll ads were enabled, etc.). Viewer activity data 710B can reflect the watch hours of the media items on the channel, the number of views the channel received, etc. Engagement data 710C can reflect the number of comments posted on the channel, the number of likes recorded for the channel, etc. Creator activity data 720D can reflect the number of media items published on the channel, the number of posts on the channel (e.g., updates by channel owners containing text and visual content), etc. Revenue data 720E can reflect the particular billing model implemented by the channel. For example, the channel can implement a SVOD (Subscription Video on Demand) model, a TVOD (Transactional Video on Demand) model, an AVOD (Advertising-Based Video on Demand and Free Ad-Supported) model, a hybrid earnings model, etc. Fanship data 720F can reflect the number of fans or subscribers the channel has. Monetization settings 720G can reflect whether mid-roll ads are enabled for the entire channel, for a portion of the channel (e.g., for a certain number of media items on the channel), whether pre-roll ads are enabled, whether post-roll ads are enabled, the category of advertisements enabled (e.g., unskippable ads, skippable ads, 5 second ads, 30 second ads, and so forth), etc.

The feature 710, 720 can first be converted into numerical data, one-hot embedding data, or any combination thereof. One-hot embedding refers to a process for encoding categorical data into a bit vector representation. A bit vector is a vector containing bit values 0 and 1. In an example, data can be represented as a binary vector that is all zero values except the data of interest, which is marked with a 1. The converted data can then be used to train model 160, which can be used to generate prediction data 730, such as expected additional earnings for a target channel.

FIG. 8 is a block diagram illustrating example architecture of a video item level AI model, in accordance with implementation of the present disclosure. As shown, channel level features 820 of a channel, media item features of video items with mid-roll ads enabled 810, and sequence features 815 can be used to train the video item level AI model. Media item features 810 can include metadata 810A, viewer activity data 810B, engagement data 810C, revenue data 810D, and monetization settings 810E. Metadata 810A can reflect logged data of each media item, regional data of each media item, timestamp data of each media item (e.g., date and time of upload, when the media items was made available for viewing, when mid-roll ads were enabled, etc). Viewer activity data 810B can reflect the watch hours of each media item, the number of views each media item received, etc. Engagement data 810C can reflect the number of comments posted for each media item, the number of likes recorded for each media item, etc. Revenue data 820E can reflect the particular billing model implemented by the media item. For example, the media item can implement a SVOD model, a TVOD model, an AVOD model, a hybrid earnings model, etc. Monetization settings 810E can reflect whether mid-roll ads are enabled for the media item, whether pre-roll ads are enabled, whether post-roll ads are enabled, the category of advertisements enabled, etc. Channel features 820 can include metadata 820A, viewer activity data 820B, engagement data 820C, creator activity data 820D, revenue data 820E, fanship data 820F, and monetization settings 820G. Metadata 810A can reflect logged data of each channel, regional data of each channel, timestamp data of each channel (e.g., date and time of channel creation, when the channel was made available for viewing, when channel level mid-roll ads were enabled, etc.). Viewer activity data 810B can reflect the watch hours of the media items on the channel, the number of views the channel received, etc. Engagement data 810C can reflect the number of comments posted on the channel, the number of likes recorded for the channel, etc. Creator activity data 820D can reflect the number of media items published on the channel, the number of posts on the channel (e.g., updates by channel owners containing text and visual content), etc. Revenue data 820E can reflect the particular billing model implemented by the channel. For example, the channel can implement a SVOD model, a TVOD model, an AVOD model, a hybrid earnings model, etc. Fanship data 820F can reflect the number of fans or subscribers the channel has. Monetization settings 820G can reflect whether mid-roll ads are enabled for the entire channel, for a portion of the channel (e.g., for a certain number of media items on the channel), whether pre-roll ads are enabled, whether post-roll ads are enabled, the category of advertisements enabled, etc. Sequence features 815 can include a periodic aggregation of earnings, such as, for example, a weekly aggregation of gross mid-roll ad earnings.

The feature 810, 820 can first be converted into numerical data, embedded data (e.g., numerical representations of the data), or any combination thereof. The sequence features can be fed into transformer encoder 830 to convert the sequence features into embedded data. Transformer encoder 830 can be an AI model that processes an input sequence and produces a continuous representation (embedding) of the input. The converted data can then be used to train the video item level AI model, represented by neural network layers 840A, 840B, and 840C). As shown, neural network layers 840A and 840B can be rectifier layers while layer 840C can be a linear layer. AI model 840C can be used to generate prediction data 850, such as expected additional earnings for a target channel. In the video item level AI model, mid-roll ads earnings are more closely tied to individual videos rather than channels.

FIG. 9 is a block diagram illustrating example architecture of a channel level AI model, in accordance with implementation of the present disclosure. As shown, channel level features 920 of a channel and media item features of video items with mid-roll ads enabled 910 can be used to train the channel level AI model. Media item features 910 can include viewer activity data 910A, engagement data 910B, revenue data 910C, and monetization settings 910D. Viewer activity data 910A can reflect the watch hours of each media item, the number of views each media item received, etc. Engagement data 910B can reflect the number of comments posted for each media item, the number of likes recorded for each media item, etc. Revenue data 920C can reflect the particular billing model implemented by the media item. For example, the media item can implement a SVOD model, a TVOD model, an AVOD model, a hybrid earnings model, etc. Monetization settings 910D can reflect whether mid-roll ads are enabled for the media item, whether pre-roll ads are enabled, whether post-roll ads are enabled, the category of advertisements enabled, etc. Channel features 920 can include metadata 920A, viewer activity data 920B, engagement data 920C, creator activity data 920D, revenue data 920E, fanship data 920F, and monetization settings 920G. Metadata 910A can reflect logged data of each channel, regional data of each channel, timestamp data of each channel (e.g., date and time of channel creation, when the channel was made available for viewing, when channel level mid-roll ads were enabled, etc.). Viewer activity data 910B can reflect the watch hours of the media items on the channel, the number of views the channel received, etc. Engagement data 910C can reflect the number of comments posted on the channel, the number of likes recorded for the channel, etc. Creator activity data 920D can reflect the number of media items published on the channel, the number of posts on the channel (e.g., updates by channel owners containing text and visual content), etc. Revenue data 920E can reflect the particular billing model implemented by the channel. For example, the channel can implement a SVOD model, a TVOD model, an AVOD model, a hybrid earnings model, etc. Fanship data 920F can reflect the number of fans or subscribers the channel has. Monetization settings 920G can reflect whether mid-roll ads are enabled for the entire channel, for a portion of the channel (e.g., for a certain number of media items on the channel), whether pre-roll ads are enabled, whether post-roll ads are enabled, the category of advertisements enabled, etc.

The features 910, 920 can first be converted into numerical data, embedded data, or any combination thereof. The converted data can then be used to train the channel level AI model, represented by neural network layers 940A, 940B, and 940C. As shown, layers 940A and 940B can be rectifier layers while layer 940C can be a linear layer. The channel level model can be used to generate prediction data 950, such as expected additional earnings for a target channel. The channel level model can capture the overall trend of a channel rather than the details of individual video items.

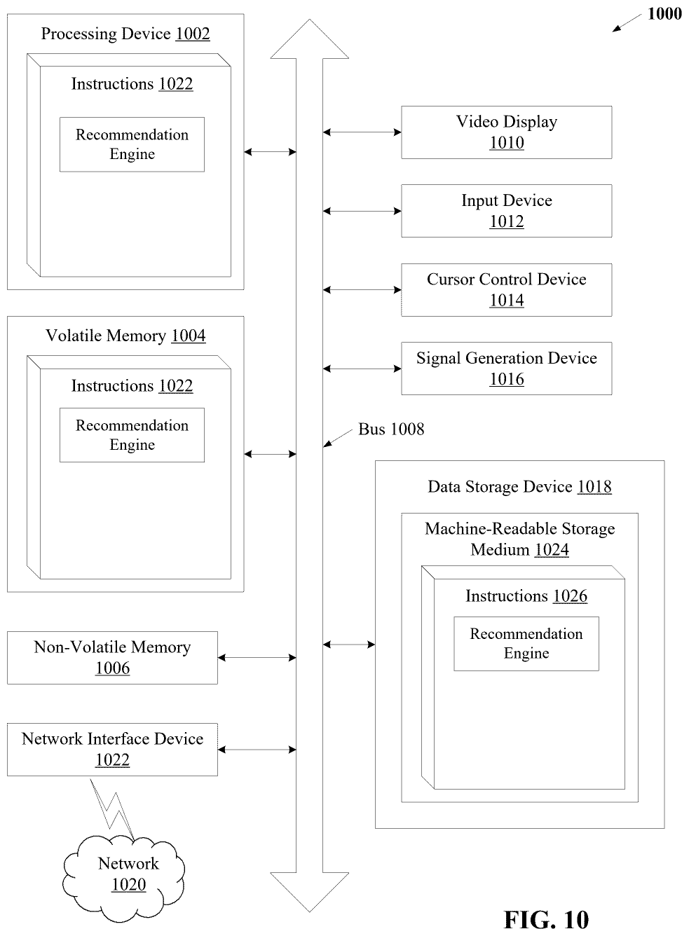

FIG. 10 depicts a block diagram of a computer system operating in accordance with one or more aspects of the present disclosure. In certain implementations, computer system 1000 can be connected (e.g., via a network, such as a Local Area Network (LAN), an intranet, an extranet, or the Internet) to other computer systems. Computer system 1000 can operate in the capacity of a client device. Computer system 1000 can operate in the capacity of a server or a client computer in a client-server environment. Computer system 1000 can be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 can include a processing device 1002, a volatile memory 1004 (e.g., random access memory (RAM)), a non-volatile memory 1006 (e.g., read-only memory (ROM) or electrically erasable programmable ROM (EEPROM)), and a data storage device 1018, which can communicate with each other via a bus 1008.

Processing device 1002 can be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1000 can further include a network interface device 1022. Computer system 1000 also can include a video display unit 1010 (e.g., an LCD), an input device 1012 (e.g., a keyboard, an alphanumeric keyboard, a motion sensing input device, touch screen), a cursor control device 1014 (e.g., a mouse), and a signal generation device 1016.

Data storage device 1018 can include a non-transitory machine-readable storage medium 1024 on which can store instructions 1026 encoding any one or more of the methods or functions described herein, including instructions encoding components of client device of FIG. 1 for implementing methods 200, 300, 500, and 600.

Instructions 1026 can also reside, completely or partially, within volatile memory 1004 and/or within processing device 1002 during execution thereof by computer system 1000, hence, volatile memory 1004 and processing device 1002 can also constitute machine-readable storage media.

While machine-readable storage medium 1024 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as ASICS, FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “receiving,” “determining,” “sending,” “displaying,” “identifying,” “selecting,” “excluding,” “creating,” “adding,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can comprise a general-purpose computer system selectively programmed by a computer program stored in the computer system. Such a computer program can be stored in a computer-readable tangible storage medium.

The methods and illustrative examples described herein are not inherently related to any particular computer or other apparatus. Various general-purpose systems can be used in accordance with the teachings described herein, or it can prove convenient to construct more specialized apparatus to perform methods 300 and 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
identifying, by a processor, a channel associated with a user of a content sharing platform;
providing an indication of one or more features associated with the channel as input to an artificial intelligence (AI) model, wherein the AI model is trained to generate predictions reflecting expected earnings from enabling a particular type of advertisement in one or more media items associated with the channel, wherein the particular type of advertisement comprises at least one of a pre-roll advertisement, a mid-roll advertisement, or a post-roll advertisement;
obtaining one or more outputs of the AI model, wherein the one or more obtained outputs comprise a prediction reflecting expected earnings from enabling the particular type of advertisement in one or more media items associated with the channel;
generating, based on the expected earnings, a targeted recommendation for the user to convey a beneficial impact of enabling the particular type of advertisement; and
sending, to the user, an indicator referencing the targeted recommendation.

2. The method of claim 1, wherein each of the features are associated with at least one of data corresponding to viewer interactions with at least one of the channel or a media item on the channel, activities performed by the user on at least one of the channel or on a media item on the channel, or metrics associated with at least one of the channel or a media item on the channel.

3. The method of claim 1, wherein the indicator is at least one of a pop-up message on a user interface associated with the channel, an email, or a text message.

4. The method of claim 1, wherein the recommendation references predicted additional earnings based on the expected earnings and estimated current earnings.

5. The method of claim 1, further comprising:
determining whether the expected earnings satisfy a threshold criterion; and
wherein sending the indicator is performed responsive to determining that the expected earnings satisfy the threshold criterion, wherein the recommendation includes a value indicative of predicted additional earnings.

6. The method of claim 1, further comprising:
responsive to determining that the channel is eligible to enable advertisements, determining whether the channel currently enables the particular type of advertisement; and
wherein providing the indication of the one or more features associated with the channel is performed responsive to determining that the channel does not currently enable the particular type of advertisement.

7. (canceled)

8. The method of claim 1, wherein the AI model is trained using historical data.

9. The method of claim 1, wherein AI model is trained using predicted data.

10. The method of claim 1, wherein the AI model is trained to provide expected earning for a media item of the channel and aggregate the expected earnings based on a number of media items on the channel.

11. The method of claim 1, wherein the AI model is trained to provide expected earnings for each media item of the channel.

12. A system comprising:
a memory; and
a processing device, coupled to the memory, the processing device to perform operations comprising:
identifying a channel associated with a user of a content sharing platform;
providing an indication of one or more features associated with the channel as input to an artificial intelligence (AI) model, wherein the AI model is trained to generate predictions reflecting expected earnings from enabling a particular type of advertisement in one or more media items associated with the channel, wherein the particular type of advertisement comprises at least one of a pre-roll advertisement, a mid-roll advertisement, or a post-roll advertisement;
obtaining one or more outputs of the AI model, wherein the one or more obtained outputs comprise a prediction reflecting expected earnings from enabling the particular type of advertisement in one or more media items associated with the channel;
generating, based on the expected earnings, a targeted recommendation for the user to convey a beneficial impact of enabling the particular type of advertisement; and
sending, to the user, an indicator referencing the targeted recommendation.

13. The system of claim 12, wherein each of the features are associated with at least one of data corresponding to viewer interactions with at least one of the channel or a media item on the channel, activities performed by the user on at least one of the channel or on a media item on the channel, or metrics associated with at least one of the channel or a media item on the channel.

14. The system of claim 12, wherein the indicator is at least one of a pop-up message on a user interface associated with the channel, an email, or a text message.

15. The system of claim 12, wherein the recommendation references predicted additional earnings based on the expected earnings and projected current earnings.

16. The system of claim 12, wherein the operations further comprise:
determining whether the expected earnings satisfy a threshold criterion; and
wherein sending the indicator is performed responsive to determining that the expected earnings satisfy the threshold criterion, wherein the recommendation includes a value indicative of predicted additional earnings.

17. The system of claim 12, wherein the operations further comprise:
responsive to determining that the channel is eligible to enable advertisements, determining whether the channel currently enables the particular type of advertisement; and
wherein providing the indication of the one or more features associated with the channel is performed responsive to determining that the channel does not currently enable the particular type of advertisement.

18. (canceled)

19. A non-transitory computer-readable medium comprising instructions that, responsive to execution by a processing device, cause the processing device to perform operations comprising:
identifying a channel associated with a user of a content sharing platform;
providing an indication of one or more features associated with the channel as input to an artificial intelligence (AI) model, wherein the AI model is trained to generate predictions reflecting expected earnings from enabling a particular type of advertisement in one or more media items associated with the channel, wherein the particular type of advertisement comprises at least one of a pre-roll advertisement, a mid-roll advertisement, or a post-roll advertisement;
obtaining one or more outputs of the AI model, wherein the one or more obtained outputs comprise a prediction reflecting expected earnings from enabling the particular type of advertisement in one or more media items associated with the channel;
generating, based on the expected earnings, a targeted recommendation for the user to convey a beneficial impact of enabling the particular type of advertisement; and
sending, to the user, an indicator referencing the targeted recommendation.

20. The non-transitory computer readable storage medium of claim 19, wherein each of the features are associated with at least one of data corresponding to viewer interactions with at least one of the channel or a media item on the channel, activities performed by the user on at least one of the channel or on a media item on the channel, or metrics associated with at least one of the channel or a media item on the channel.
